(19) United States
(12) Patent Application Publication
(10) Pub. No.: US 2003/0179847 A1
(43) Pub. Date: Sep. 25, 2003

(54) Fixture for cooling the core of a nuclear reactor

(76) Inventor: Friedrich Leibold, Happurg (DE)

Correspondence Address: LERNER AND GREENBERG, P.A., Post Office Box 2480, Hollywood, FL, 33022-2480, US

(21) Appl. No.: 10/418,990

(22) Filed: Apr. 18, 2003

Related U.S. Application Data
(63) Continuation of application No. PCT/EP01/11752, filed on Oct. 11, 2001.

(30) Foreign Application Priority Data
Oct. 20, 2000 (DE) 100 52 282.3

(51) Int. Cl. G21C 9/00

(52) U.S. Cl. 376/282

(57) ABSTRACT

A fixture for cooling a core of a nuclear reactor, in particularly for a boiling water reactor, has spray nozzles and are disposed above the core. It is provided that the distributor pipes are mounted in displaceable fashion. In this manner, mechanical damage from thermal expansion and contraction is limited or avoided altogether.

### CROSS-REFERENCE TO RELATED APPLICATION

This application is a continuation of copending International Application No. PCT/EP01/11752, filed Oct. 11, 2001, which designated the United States and was not published in English.

### FIELD OF THE INVENTION

The invention relates to a fixture for cooling the core of a nuclear reactor, particularly a boiling water reactor, wherein distributor pipes, which are provided with spray nozzles, are disposed above the core.

This type of fixture, which is known as a core spray system, is known from German Patent DE 32 45 451 C2, corresponding to U.S. Pat. No. 4,557,890. It is frequently disposed in what are known as core lids.

This kind of core spray system is activated and charged with cold water only in emergencies, for instance given core overheating.

Normally, the core spray system contains an outer distributor ring from which inwardly directed distributor pipes emanate, and are provided with spray nozzles. The distributor ring and the distributor pipes are fastened to a bearing grate, which can be held in turn by the reactor lid.

If cold water (e.g. 20° C.) is introduced into the pipes of the core spray system for purposes of cooling the core, the cooling of the pipes of the core spray system causes the length of the pipes to change, the pipes having previously assumed the high temperature (e.g. 300° C.) in the steam space of the reactor. A sudden length change of several centimeters can lead to pipe damage and unwanted pipe vibrations. The vibrations are triggered by a steam-water mixture flowing vertically in the steam space.

### SUMMARY OF THE INVENTION

It is accordingly an object of the invention to provide a fixture for cooling the core of a nuclear reactor that overcomes the above-mentioned disadvantages of the prior art devices of this general type, with which damage resulting from thermal expansions or contractions is avoided. In addition, vibrations of existing pipes that can be attributed to temperature differences can also be prevented.

With the foregoing and other objects in view there is provided, in accordance with the invention, a fixture for cooling a core of a nuclear reactor. The fixture contains distributor pipes having spray nozzles disposed above the core. The distributor pipes are mounted such that the distributor pipes can be displaced.

In accordance with an added feature of the invention, the distributor pipes are mounted such that the distributor pipes can be displaced in a longitudinal direction.

In accordance with a further feature of the invention, a bearing grate is provided, and the distributor pipes are mounted to the bearing grate such that the distributor pipes can be displaced laterally.

In accordance with another feature of the invention, holders are provided, and the distributor pipes are mounted in the holders which are spaced unevenly along the distributor pipes.

In accordance with a concomitant feature of the invention, a bearing ring for a core lid is provided. The distributor pipes are mounted to the bearing ring.

Other features which are considered as characteristic for the invention are set forth in the appended claims.

Although the invention is described herein as embodied in a fixture for cooling the core of a nuclear reactor, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

The invention relates to a fixture for cooling a core of a nuclear reactor with which damage resulting from thermal expansions or contractions is avoided. In addition, vibrations of existing pipes that can be attributed to temperature differences can also be prevented. The fixture can be incorporated into existing parts and should be easy to inspect.

The object is inventively achieved by mounting the distributor pipes in a displaceable fashion. This mounting achieves the advantage that expansions or contractions of the pipes as a consequence of the introduction of cold water into the hot pipes cannot lead to mechanical stresses. Consequently, damage and even vibrations are advantageously avoided.

The fixture for cooling the core has distributor pipes that are mounted such that they can be displaced longitudinally. Known plain bearings can be used to that end. According to another example, the distributor pipes are mounted on a bearing grate such that they can be displaced laterally. In this manner, thermal expansions in a radial direction cannot cause mechanical damage. It is also possible to mount the distributor pipes such that they can be displaced longitudinally and laterally.

Suitable holding fixtures for the distributor pipes which permit thermal expansions in the radial direction have a respective recess in the horizontal direction transverse to the pipe, which allows lateral movement of the pipe. But the pipes are fixed in the vertical direction.

For instance, the distributor pipes are mounted in holders that are unevenly spaced along the distributor pipe. This brings the advantage that vibrations of the distributor pipe cannot cause disturbing standing waves.

The distributor pipes are mounted in a bearing ring for a core lid, for instance.

For easier inspection, the overall fixture for cooling the core can be detachable from the core lid as one assembly.

The fixture for cooling the core of the nuclear reactor inventively achieves the unique advantage that feeding cold water into the hot pipes of the cooling fixture does not damage the pipes or cause vibrations as a result of thermal expansion or contraction that is caused by the temperature difference.

I claim:

1. A fixture for cooling a core of a nuclear reactor, comprising:
distributor pipes disposed above the core and having spray nozzles, said distributor pipes being mounted such that said distributor pipes can be displaced.

2. The fixture according to claim 1, wherein said distributor pipes are mounted such that said distributor pipes can be displaced in a longitudinal direction.

3. The fixture according to claim 1, further comprising a bearing grate, and said distributor pipes are mounted to said bearing grate such that said distributor pipes can be displaced laterally.

4. The fixture according to claim 1, further comprising holders, and said distributor pipes are mounted in said holders which are spaced unevenly along said distributor pipes.

5. The fixture according to claim 1, further comprising a bearing ring for a core lid, said distributor pipes are mounted in said bearing ring.

6. A fixture for cooling a core of a boiling water nuclear reactor, comprising:
distributor pipes disposed above the core and having spray nozzles, said distributor pipes being mounted such that said distributor pipes can be displaced.
